(19) United States
(12) Patent Application Publication
(10) Pub. No.: US 2005/0231596 A1
(43) Pub. Date: Oct. 20, 2005

(54) Testing apparatus for digital video camera anomalies

(76) Inventor: Joseph Robert Marchese, Ray, MI (US)

Correspondence Address: JAMES D. STEVENS;REISING, ETHINGTON, BARNES, KISSELLE, P.C., P.O. BOX 4390, TROY, MI, 48099, US

(21) Appl. No.: 11/090,562

(22) Filed: Mar. 25, 2005

Related U.S. Application Data
(60) Provisional application No. 60/557,914, filed on Mar. 31, 2004.

(51) Int. Cl. H04N 5/228

(52) U.S. Cl. 348/187

(57) ABSTRACT

A testing method and apparatus for use with video cameras to determine various camera video output characteristics such as frame rate and the limits of the camera's ability to encode high motion video. In one embodiment, the testing apparatus includes a wheel that includes a pattern or other indicia along with a motor to rotate the wheel and a computer to provide software control of the motor and camera performance reporting. In another embodiment, the testing apparatus includes a computer that displays an alternating pattern or other motion that is recorded by the camera and displayed on a second monitor. The displayed motion can be adjusted via software on the computer to determine its effect on the camera's ability to record and process the displayed motion video.

### CROSS-REFERENCE TO RELATED APPLICATION

This application claims the priority of U.S. Provisional Application No. 60/557,914, filed Mar. 31, 2004, the entire contents of which are hereby incorporated by reference.

### TECHNICAL FIELD

The present invention relates generally to digital video and, in particular, to the testing of frame rate, interlacing effects, and codec-based degradation of video frame rate and streaming performance in high motion video.

### BACKGROUND OF THE INVENTION

Digital video processing introduces anomalies in video that can cause significant degradation in video image quality. This can be undesirable at best for normal video recording and critically problematic in security monitoring and other surveillance applications. These anomalies can be difficult to quantify with live subject video, making it hard to accurately compare competing cameras and determine the effects of real time video compression.

Camera video output can be tested for a number of different attributes, of which the present invention is primarily concerned with certain of those related to frame rate and image quality. A first testable attribute is interlacing mode and latency. Cameras that output an interlaced image can exhibit image tear when recording a fast moving subject. Movement of the subject in the camera field of view between recording of the even and odd sets of scan lines causes the image from the even scan lines to be shifted from those of the odd scan lines. The interlacing latency indicates the amount of time delay between the odd and even scan line recordings.

A second testable attribute is camera frame rate. Cameras normally have a specified frame rate of, for example, 30 frames per second (fps). However, actual frame rates for a camera sometimes vary significantly from their advertised specification. Accurate determination of a camera's actual frame rate can be difficult.

A third attribute relates to degradation of image quality due to the use of codecs and especially in recording of high motion video; that is, video where there is a large degree of motion and/or fast motion in the recorded image. The processing capability of the camera or other processor can limit the available frame rate. In MPEG compression, for example, higher compression levels can become impossible for images containing a large degree of motion. This can lower the frame rate of streaming video and, in some instances, cause a complete interruption or stoppage of the video stream.

### SUMMARY OF THE INVENTION

The present invention provides an apparatus for testing a video camera. The testing apparatus comprises a computer that includes a monitor or other display screen and a testing program that is operable to control a presentation of motion for use in testing of the video camera. The testing program operates when being executed by the computer to provide a user interface that is displayed on the display screen, with the program permitting user selection of at least one attribute of the presentation of motion via the user interface. In one embodiment, the testing apparatus further includes a display wheel and a motor for providing rotation of the display wheel, with the computer program being connected to the motor via a communications link so that the motor speed can be adjusted via the program's user interface. In another embodiment, the presentation of motion is displayed on the computer screen itself so that the camera under test is focused on the display screen to record the motion.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a diagram showing a testing apparatus constructed in accordance with the present invention;

FIG. 2 is a computer screen display window depicting a graphical user interface generated by the software used in the testing apparatus of FIG. 1;

FIG. 3 is front view of the circular wheel used in the testing apparatus of FIG. 1;

FIGS. 4 and 5 are digital image frames from a video capture of the spinning wheel of FIG. 1 showing image tear that results from the use of interlaced video mode;

FIGS. 6 and 7 are examples of successive digital image frames from a non-interlaced video capture of the spinning wheel of FIG. 1;

FIGS. 8 and 9 are additional examples of successive digital image frames as in FIGS. 6 and 7, but using a different rotational wheel speed;

FIG. 10 is a checkerboard pattern that can be used on the wheel of FIG. 2 to determine the effect of motion on a camera's output quality and frame rate;

FIG. 11 is a second testing apparatus that utilizes a computer to create and display patterns used in video camera testing;

FIG. 12 is a screen display of a partial pattern generated by the software used by the testing apparatus of FIG. 11; and

FIG. 13 is a screen display of a window depicting a graphical user interface generated by the software used in the testing apparatus of FIG. 11.

### DETAILED DESCRIPTION OF THE PREFERRED EMBODIMENTS

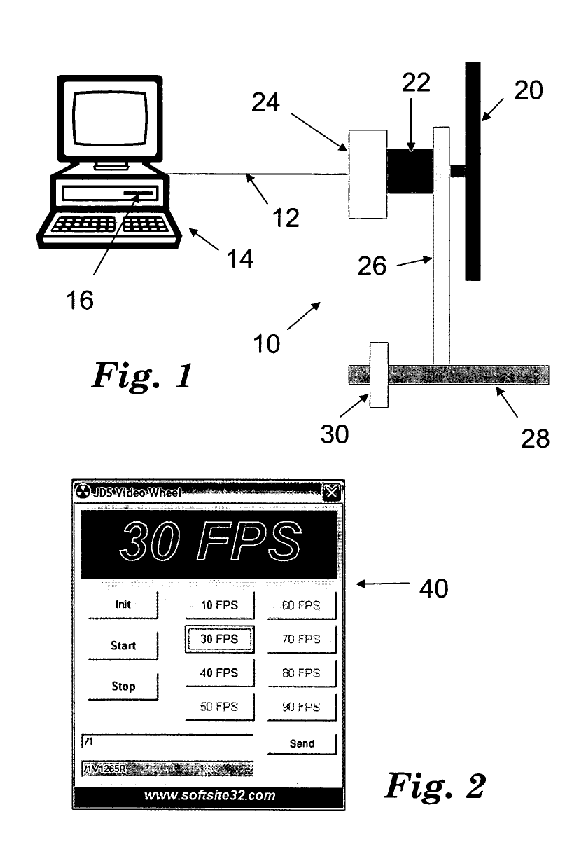

Referring to FIGS. 1-3, there is shown a testing apparatus constructed in accordance with the present invention. FIG. 1 depicts the testing apparatus which includes a motorized testing wheel device 10 connected via a communications link 12 to a computer 14 running a testing program 16. The testing wheel device 10 includes a circular disk 20, stepper motor 22, motor driver 24, and frame 26 mounted on a base 28 with a clamp 30 that can be used to hold the device 10 to a test bench or table. The disk 20 is a wheel formed from plastic or other lightweight/low mass material of sixteen inch diameter or any other suitable size. The stepper motor 22 can be a digital stepper motor such as a NEMA 23 and is preferably high precision device having a suitable driver 24 that permits high precision control of the motor, although these devices need only be as precise as required or desired for a particular application. The frame 26 is a rigid frame mounted on the base 28, and is used to support the wheel 20, motor 22, and drive 24.

The computer 14 can be any suitable microprocessor-based device such as a PDA, laptop, or standard desktop computer. The testing program 16 provides a user interface 40 such as in FIG. 2 and permits user control of the motor 22 to drive the wheel 20 to a desired RPM. Communication via link 12 can be via serial, parallel, or IP protocol, and can be hardwired or wireless.

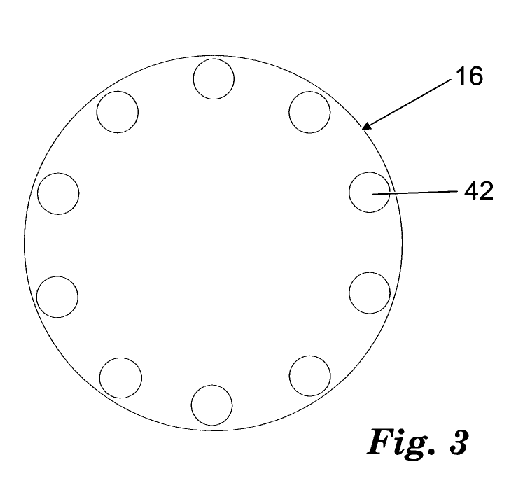

FIG. 3 depicts the wheel 20 which in the illustrated embodiment includes ten graphical images 42 equally spaced about its circumference. Any suitable indicia can be used and preferably each is numbered in order in either the clockwise (CW) or counterclockwise (CCW) direction. For example, playing cards attached or imprinted on the wheel can be used, numbered from the Ace, 2, 3 . . . 10, with alternate cards being of a different color suit.

In use, the camera under test is placed in front of the wheel such that the camera's field of view includes at least one of the cards. Then, the motor 22 is initialized and started under control of program 16 and successive camera images are recorded and analyzed. With the ten spaced cards and a rotational speed of 180 rpm (3 revolutions per second), a camera that outputs a true 30 fps will provide consecutive image frames each having a consecutive card located at the same spot in the image. If the true camera speed is slightly above or below this, the location of the playing cards in the successive images will shift in either the CW or CCW directions. Using this, the actual camera frame rate can be determined. One method of determining frame rate is to provide a coarse synchronization of the wheel speed to the frame rate using the software 16 by selecting the proper speed setting (e.g., 10, 30, or 40 fps) via the user interface 40 of FIG. 2. Then, based on the degree of shifting of the graphical images from one frame to the next, the actual speed can be determined. Another method is to utilize the software program to first perform a coarse adjustment of the speed of wheel 20 as mentioned above, and then secondly to make fine adjustments to the wheel speed using a pair of up/down incremental adjustment buttons via the user interface (not shown in FIG. 2). The program readout would then automatically calculate and display the frame rate that corresponds to the particular instantaneous speed setting, as indicated in FIG. 2.

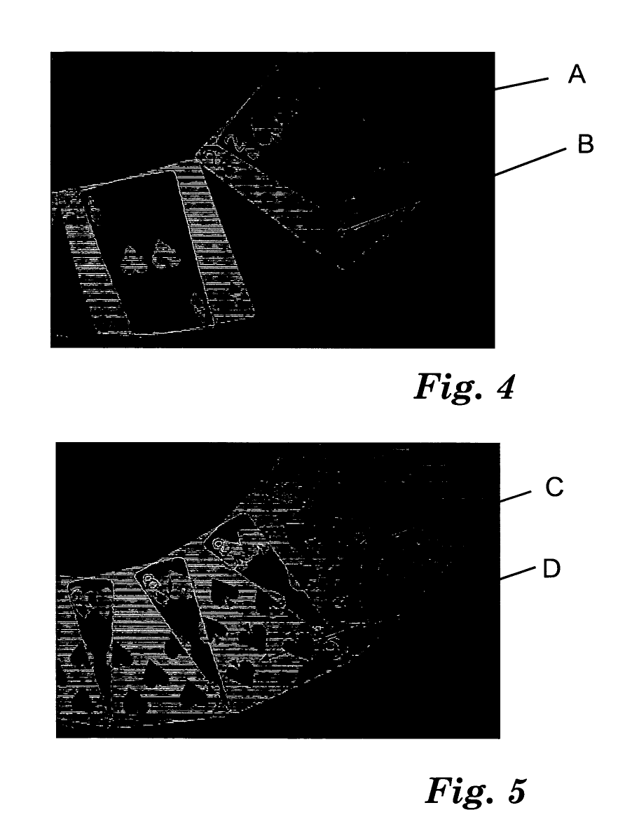

FIG. 4 provides an example of the effect of an interlaced video mode. This image was recorded at 704×480 resolution from an analog source (NTSC) transmitting 30 fps and digitized at 10 fps. Arrow A shows the odd scan lines, and arrow B shows the even scan lines. This image depicts an example of image tear due to the speed of the subject passing by the camera field of view and the latency inherent in interlaced images. By knowing image scale (or by showing a scale on the wheel), and knowing the rotational speed, the time difference in the fields can be calculated and this number represents the interlacing latency. For this 10 fps digitization, running the wheel 20 at 60 rpm will result in the playing cards occupying the same position with the camera image from one frame to the next.

FIG. 5 shows an example where the wheel is rotating at 180 rpm resulting in the image tear being more pronounced. Arrows C and D are the even and odd interlaced fields of a single NTSC image. The images move CCW when played back, indicating that the video feed is not 30 fps. Adjusting the wheel speed in precise increments until the images are distinct, “static” on screen and in sequence, the exact frame rate of the camera can be figured by a simple formula (here it is wheel rpm/⁶). Other graphical image spacings on the circle will yield different formulas and rpm capabilities.

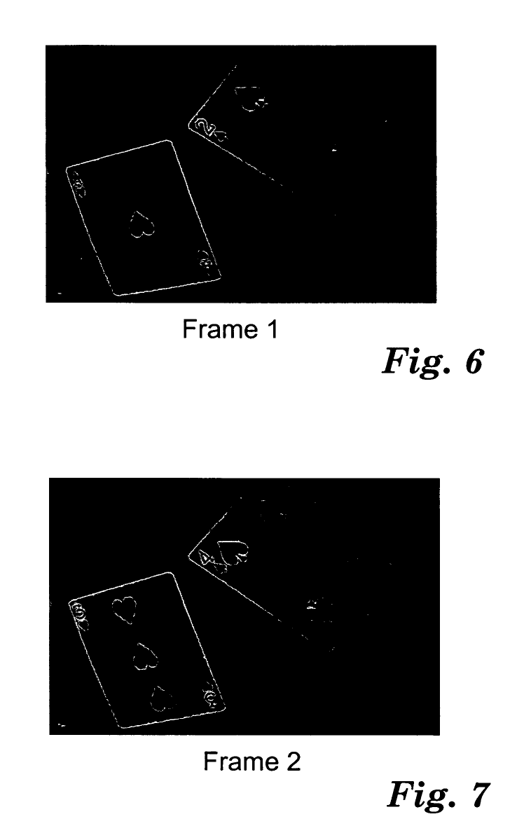

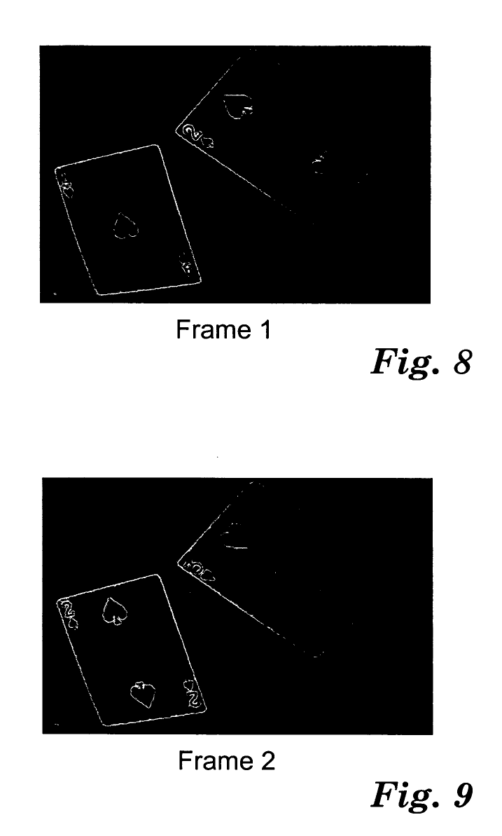

FIGS. 6 and 7 show examples of successive image frames at a wheel speed of 360 rpm. These images are progressive scan (non-interlaced) and do not exhibit image tear. This sequence shows the Ace of hearts in Frame 1, and then the 3 of hearts in the location in the next successive frame (Frame 2). The 2 of spades in Frame 1 is missing in Frame 2, indicating that it had already moved past the position where the Ace of hearts is (Frame 1) and further off screen between video refreshes. Thus, the card count is incremented by twos for the same position in successive images. This validates that the frame rate of the camera is 360/6=60 and ½ of that which is 30 fps. FIGS. 8 and 9 show examples of successive non-interlaced image frames at a wheel speed of 180 rpm. In the successive frames, the cards located at the same place in the image are incrementing numerically by one indicating a frame rate of 30 fps.

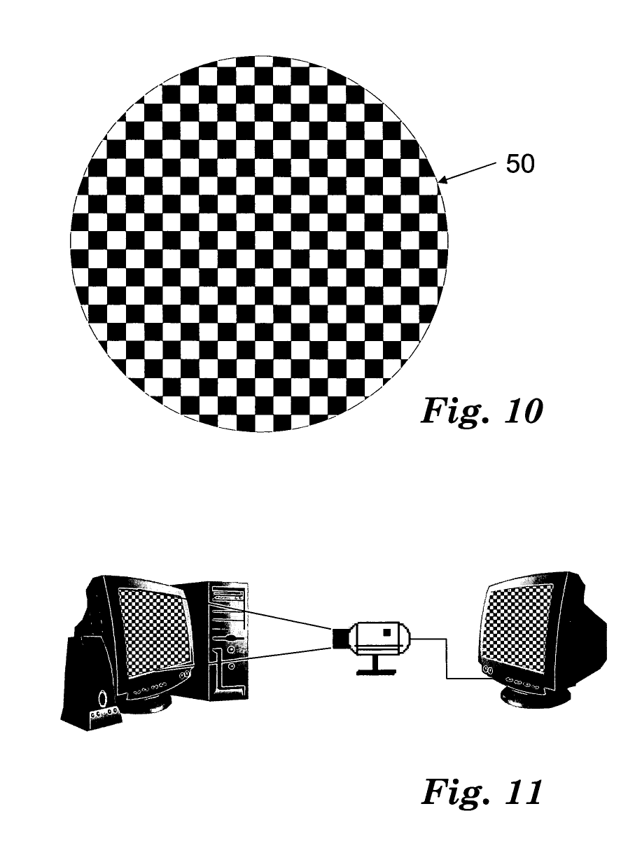

Apart from determining frame rate and detecting interlacing and interlacing inherency, the testing apparatus 10 can also be used to evaluate the ability of the camera to carryout real time video compression. This can be used either for cameras having built-in compression capability or for a separate compression equipment or algorithm running in a computer. FIG. 10 depicts another pattern 50 that can be applied to wheel 20. It is a checkerboard pattern made up of, for example, ¼ inch alternating black and white (or other color) blocks. The wheel is then rotated at a desired speed, e.g., 180 rpm. This creates a great deal of motion (changing pixels) within the camera field of view, and the high quantity of changing pixels tasks MPEG, H.263, G77 and possibly other types of compression algorithms and requires extensive CPU-intensive calculations. The camera video is then evaluated to determine the ability of the compression to compress and stream the video in real time. For lower compression levels, the video will display, consuming 4-8 mbps/sec, similar to JPEG of other discreet image formats. At average compression levels, the video will often display sporadically. At higher compression levels, the video can cease to stream entirely. This is due to the fact that the image is changing too fast for the algorithm to run effectively. The speed of the wheel can be adjusted to test the operation of the video compression at different wheel speeds.

An alternative approach for testing the ability of the compression process to keep up with the video is depicted in FIGS. 11-13. In this embodiment, the testing apparatus includes a computer program that generates a checkerboard pattern on a computer screen which is used in place of the spinning wheel pattern of FIG. 10. Motion occurs by flashing alternating screens in which the black and white squares of the checkerboard pattern switch place. The camera under test is then directed such that the computer screen substantially fills its field of view and the compressed video image stream is then examined on a second monitor. The computer screen used to display the checkboard pattern recorded by the camera should be one with a suitably high refresh rate relative to the frame speed of the camera; for example, a crt with a refresh rate above 30 Hz can be used. The rate at which the checkerboard pattern switches (inverts) its color can be selected to be approximately equal to the camera frame rate.

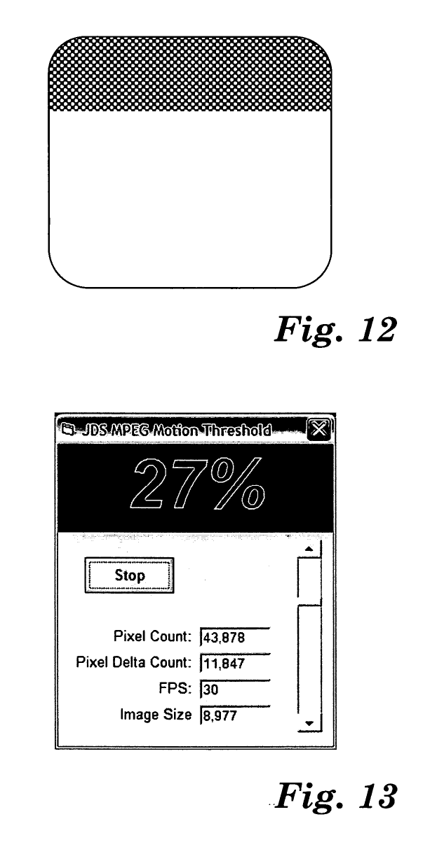

This computer-based control of the motion enables quantifiable measurements to be made of the ability of a camera or separate compression equipment (such as a computer) to generate compressed video in the presence of a high-motion subject. It also allows one to iteratively test and adjust the compression level so as to determine the best compromise between compression and quality and continuity of streamed video for a particular application. As shown in FIGS. 12-13, this can be accomplished using a program that controls the checkerboard screen display. The user interface for the program is shown in FIG. 13. The checkerboard pattern can either use black and white, or different colors, or can rotate through a variety of colors. Alternatively, other types of motion can be used other than a checkerboard pattern. The rate of switching (flashing) of the checkerboard pattern is controlled by setting the frame rate (FPS) which in the illustrated example is 30 fps. Using the slider at the right of the program's user interface, the user can set the desired amount of motion by determining how much of the screen contains the alternating checkerboard pattern. The program displays the total number of pixels as well as the number that are changing. In the example shown, 27% of the screen (i.e., of the total pixels) are be used for displaying motion, as indicated by the partial checkerboard pattern shown on the computer screen in FIG. 12. By adjusting this percentage in accordance with the amount of motion expected for the particular camera application, the camera compression level can then be adjusted as desired to find the best compromise between compression and continuity of the video stream.

For MPEG compression testing, with a sufficient high amount of motion, the MPEG routine used in some cameras will display one or both of two different anomalies. First, the routine will try to reduce the resolution to maintain the stream of frames at the particular camera frame rate. This causes pixelization of the image. Second, the compression routine can at some point fail completely by either intermittent interruptions or a complete stoppage of transmission altogether. Where the testing apparatus is being used to tune the camera and compression algorithm to a particular application, the user can set the program to generate the amount of motion expected and, upon detecting either of the above anomalies, can adjust the compression ratio (bit rate) of the MPEG routine until it is able to properly process the video. Apart from setting up a particular camera for recording, this testing apparatus can also be used to compare cameras or MPEG routines from different manufacturers to determine how much motion a particular camera or compression routine can tolerate.

It is to be understood that the foregoing description is not a description of the invention itself, but of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above or where the statement specifically refers to “the invention.” Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. An apparatus for testing a video camera, comprising a computer that includes a display screen and a testing program operable to control a presentation of motion for use in testing of the video camera, wherein the testing program operates when being executed by said computer to provide a user interface that is displayed on said display screen, with said program permitting user selection of at least one attribute of the presentation of motion via said user interface.

2. An apparatus as defined in claim 1, wherein said testing program operates to generate the presentation of motion as a changing pattern displayed on said display screen.

3. An apparatus as defined in claim 2, wherein said user interface permits user control of the pattern displayed on said screen.

4. An apparatus as defined in claim 1, further comprising:
a base;
a motor supported by said base and having an output shaft; and
a display wheel supported by said output shaft such that said wheel can be rotated by operation of said motor;
wherein said computer is connected to said motor by a communications link, and wherein the presentation of motion is provided by rotation of said display wheel at a speed selected by a user via said user interface.

5. An apparatus as defined in claim 4, wherein said user interface permits user selection of different frame rates and wherein said computer operates under control of said program and in response to user selected frame rate to cause said motor to run at a speed corresponding to said frame rate.

6. An apparatus as defined in claim 5, wherein said display wheel includes indicia positioned at different angular locations on said wheel, and wherein said computer causes said motor to rotate at a speed that is synchronized with said frame rate so that differences between the user selected frame rate and an actual frame rate of a camera focused on said wheel can be determined based on changes in the position of indicia within sequential camera images that are outputted by the camera.

7. An apparatus as defined in claim 1, wherein said computer is connected to said motor via a motor driver.

8. An apparatus as defined in claim 1, wherein said motor comprises a stepper motor.

9. An apparatus as defined in claim 1, wherein said user interface displays at least one number which quantifies said attribute.

10. An apparatus as defined in claim 1, wherein said attribute comprises the percentage of the display screen used for the presentation of motion.

11. An apparatus for testing video cameras, comprising:
a base;
a motor supported by said base and having an output shaft;
a display wheel supported by said output shaft such that said wheel can be rotated by operation of said motor; and
a computer connected to said motor by a communications link, said computer having a program stored in said computer and being operable upon execution of said program to display a user interface and to control operation of said motor at different selectable rotational speeds based on user input received by said computer via said user interface.

12. An apparatus as defined in claim 11, wherein said user interface permits user selection of different frame rates and wherein said computer operates under control of said program and in response to user selected frame rate to cause said motor to run at a speed corresponding to said frame rate.

13. An apparatus as defined in claim 12, wherein said display wheel includes indicia positioned at different angular locations on said wheel, and wherein said computer causes said motor to rotate at a speed that is synchronized with said frame rate so that differences between the user selected frame rate and an actual frame rate of a camera focused on said wheel can be determined based on changes in the position of indicia within sequential camera images that are outputted by the camera.

14. An apparatus as defined in claim 11, wherein said computer is connected to said motor via a motor driver.

15. An apparatus as defined in claim 11, wherein said motor comprises a stepper motor.

16. An apparatus as defined in claim 11, wherein said display wheel includes ten indicia angularly spaced by equal amounts about the surface of said wheel.

17. An apparatus as defined in claim 11, wherein said user interface includes at least one user selectable input corresponding to a fixed frame rate.

18. An apparatus as defined in claim 17, wherein said user selectable input comprises a button that corresponds to a frame rate of 30 frames per second.
